(19) United States
(12) Patent Application Publication
(10) Pub. No.: US 2011/0055723 A1
(43) Pub. Date: Mar. 3, 2011

(54) COLLABORATIVELY INTERACTIVE MICRO-BLOG POSTS

(76) Inventors: Simon Samuel Lightstone, Waterloo (CA); Aaron Samuel Mirsky, Jerusalem (IL)

(21) Appl. No.: 12/868,231

(22) Filed: Aug. 25, 2010

Related U.S. Application Data
(60) Provisional application No. 61/236,739, filed on Aug. 25, 2009.

(51) Int. Cl. G06F 3/01; G06F 15/16

(52) U.S. Cl. 715/752

(57) ABSTRACT

There is provided methods of interactive and collaborative communication within a micro-blogging service. A micro-blog posting may be defined having an interactive type (e.g. “Task”, “Confirm”, etc.). The post may be communicated by the service for collaboration through interactions. The service may maintain a state of the micro-blog post in accordance with the interactions (e.g. received in reply communications). Respective micro-blog posts may be presented (viewed) in accordance with the interactive type and state. For example, a micro-blog post may be presented in a web-based viewing interface with a control defined in response to the interactive type and state for invoking an interaction/reply.

### CROSS REFERENCE

This application claims the benefit of U.S. Provisional Application No. 61/236,739, filed Aug. 25, 2009 and incorporated herein by reference.

### FIELD

The present application relates generally to electronic communications and group collaborative and interactive tools, for example, enabling micro-blog posts to be collaborative and interactive among a group of users.

### BACKGROUND OF THE INVENTION

Computers are often useful to communicate electronic messages from one user to another or from one user to many users. Micro-blogging refers to generally short (140 characters or less) communications posted from one user to one or more users who are following the communications of the posting user. Following users may be enabled to reply to such postings. A group of users may be enabled to follow one another's micro-blog postings for group-based electronic communications. A web browser based user interface (in accordance with one or more standards or protocols such as HTML, HTTP and TCP/IP, among others) may be configured for posting and viewing one's own micro-blog and those of others. Twitter® and Yammer™ are examples of available micro-blogging services. Twitter is generally a more public service while Yammer is generally more private or enterprise-based, providing restrictions on group membership to users from a same organisation. Facebook® provides similar electronic communication services to a group of “friends”. It is desirous to make micro-blog communications more collaborative and interactive.

### SUMMARY

There is provided methods of interactive and collaborative communication within a micro-blogging service. A micro-blog posting may be defined having an interactive type (e.g. “Task”, “Confirm”, etc.). The post may be communicated by the service for collaboration through interactions. The service may maintain a state of the micro-blog post in accordance with the interactions (e.g. received in reply communications). Respective micro-blog posts may be presented (viewed) in accordance with the interactive type and state. For example, a micro-blog post may be presented in a web-based viewing interface with a control defined in response to the interactive type and state for invoking an interaction/reply.

In accordance with one method aspect of the invention, there is provided a method of facilitating collaborative communication comprising: receiving a micro-blog post comprising an interactive type for facilitating interaction with the micro-blog post; storing the micro-blog post and maintaining a state, in accordance with the interactive type; communicating the micro-blog post in accordance with the respective interactive type and state to facilitate interacting with the micro-blog post; and updating the state in response to a reply communication representing an interaction with the micro-blog post. The step of communicating may comprise providing a viewing interface for viewing the micro-blog post in a web browser, said viewing interface comprising a control defined in response to the interactive type and state for interacting with the micro-blog post. The method of may further comprise defining and storing user profiles comprising data identifying respective users and specifying how to communicate micro-blog posts among the respective users and wherein the step of communicating is responsive to the user profiles thereby to selectively present the micro-blog post for collaborative interaction. The method may further comprise updating the communicating of the micro-blog post in response to the updating of the state.

In another method aspect, there is provided method of facilitating collaborative communication comprising: providing a web-based communication interface for receiving respective electronic communications, each electronic communication comprising data defining a particular micro-blog post and an interactive type associated to the particular micro-blog post; providing a web-based viewing interface for presenting respective micro-blog posts, the viewing interface configured to present a particular micro-blog post in accordance with rules responsive to the associated interactive type to facilitate interacting with the particular micro-blog post and further configure to define and send an electronic communication representing the interaction; and providing a web-based communication interface for receiving the electronic communication representing an interaction with a particular micro-blog post. The method may comprise processing the electronic communication representing the interaction and updating the viewing interface presenting the particular micro-blog in response. The method may comprise processing and storing the electronic communication in accordance with the interactive type. The method may comprise providing a web-based interface for composing a particular micro-blog post and associated interactive type. The method may comprise defining and storing user profiles comprising data identifying respective users and specifying how to communicate micro-blog posts among the respective users and wherein the step of providing a web-based viewing interface is responsive to the user profiles thereby to selectively present the particular micro-blog posts for collaborative interaction. The interactive type may indicate one of a “CONFIRM”, “POLL”, “TASK”, “BUDGET/COST”, “LIST BUILD”, “QUESTION & ANSWER” “MULTIPLE CHOICE” type of interactive micro-blog post.

The viewing interface may comprise a web-page for use by a web browser of a client computer system. The client computer system, web browser and/or web-page may be configured to provide an AJAX-based framework for communicating the electronic communications.

In accordance with a further method aspect, there is provided a method of interactive and collaborative communication comprising: receiving a micro-blog post from a micro-blogging service, said micro-blog post comprising an interactive type, said service maintaining a state of said micro-blog post for facilitating interaction; and communicating a reply to the micro-blogging service in accordance with the interactive type, the reply representing an interaction with the micro-blog post to invoke an updating of the state. The method may comprise receiving an update to the micro-blog post from the micro-blogging service in response to the updating of the state. The method may comprise presenting the micro-blog post in accordance with the interactive type to facilitate an interaction. The micro-blog post may be presented in a viewing interface in accordance with the interactive type and state of the micro-post. The method may further comprise composing and sending to the micro-blogging service a micro-blog post comprising an interactive type for further communication for collaboration.

In accordance with a further method aspect, there is provided a method interactive and collaborative communication comprising: composing and sending to a micro-blogging service a micro-blog post comprising an interactive type; wherein said micro-blogging service is configured to maintain a state of said micro-blog post, communicate the micro-blog post for interaction in accordance with the interactive type and state, and receive at least one reply defining said interaction to update the state. The method may comprise receiving and presenting the micro-blog post in a viewing interface in accordance with the interactive type and state.

System (e.g. client computer, server) and computer programme products as well as further features will be apparent to those of ordinary skill in the art.

### BRIEF DESCRIPTION OF THE DRAWINGS

An embodiment of the invention will now be described by way of example only with reference to the following drawings in which:

FIG. 1 is a flow chart of operations for posting an electronic communication with interactive content;

FIGS. 2A to 2F are representative screenshots, in accordance with one embodiment, of a user interface for posting an electronic communication with interactive content (for example by a first user using a first communication device) and for interacting with such communication and interactive content (for example by a second user using a second communication device);

FIGS. 3A to 3F are representative screenshots, in accordance with another embodiment, of a user interface for posting an electronic communication with interactive content and for interacting with such interactive content by one or more users;

FIG. 4 is a block diagram showing an example communication network comprising a server and a computer coupled via a public, wide area network for communicating interactive micro-blog posts via a web site in accordance with an embodiment.

For convenience, like numerals in the description refer to like structures in the drawings.

### DETAILED DESCRIPTION

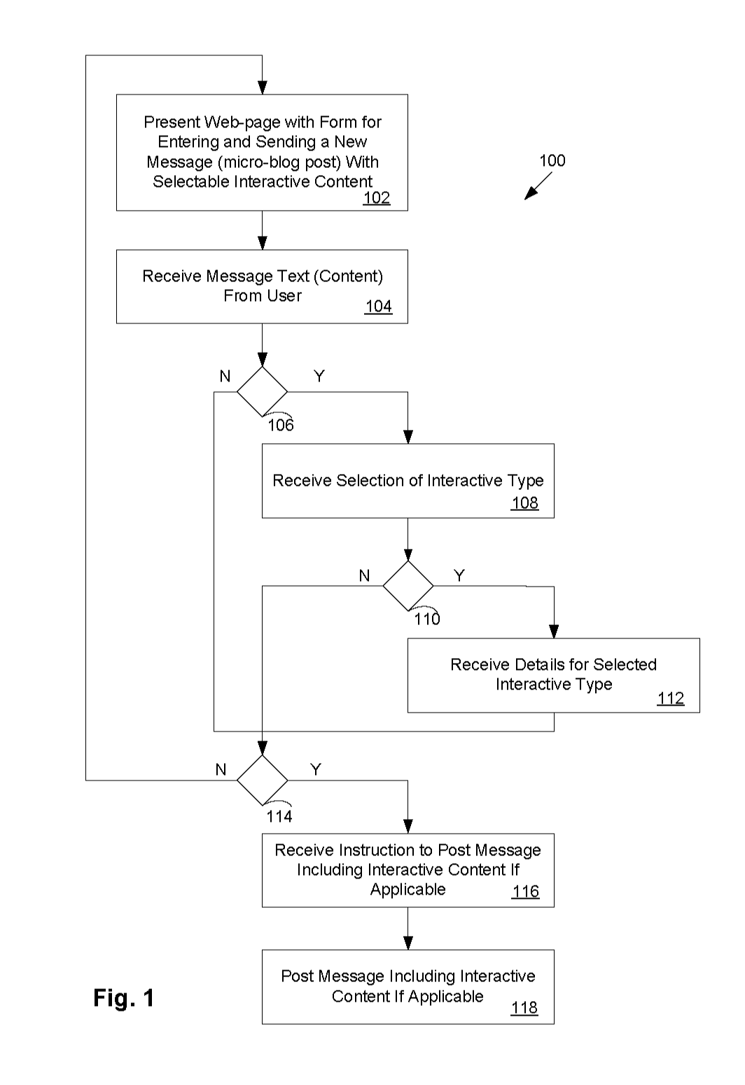

FIG. 1 illustrates a flowchart of operations 100, in accordance with one embodiment, for posting an electronic communication (to a micro-blog) which operations provide choice whether to include predefined types of interactive content. The operations may be performed by a web-enabled computer (electronic communication device) configured with a web browser or native application, as further described. At step 102, the computer presents a form for receiving a new message (communication) for example, via a web-page. As step 104, the computer receives text from the user for defining the message. Via branch Y at 106, if the user desires interactive content to be included, the computer provides a choice option to enable the message to be interactive, for example, providing a selectable control via the web-page. A drop down list (or other user interface feature) may provide a selection of types of interactive content. For example, interactive content types may include “TASK”, “CONFIRM”, “POLL”, “CHOICE” etc as described later).

The computer receives a type selection (step 108) and if applicable (Y branch at step 110), provides a further interface to receive additional details (step 112) for the selected type. Via Y branch at step 114, (e.g. when the post is determined to be complete), the computer receives (step 116) a user instruction and posts (step 118) the message to the server providing the micro-blogging services. It will be apparent that at step 106, if no interactive content is desired, or at step 110, if no additional information is necessary for the interactive content, operations may move to step 114. A user may repeat steps 102 and following, choosing to start over via branch N at step 114.

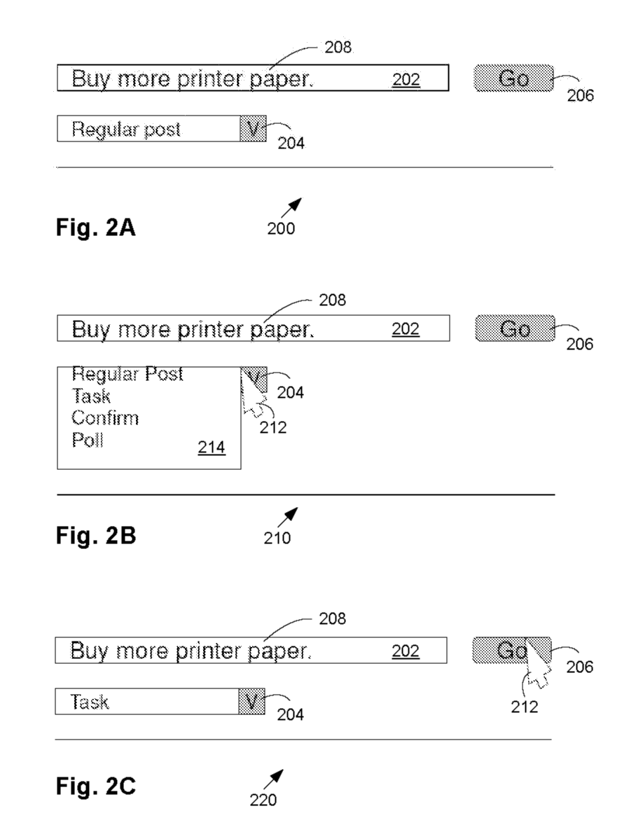

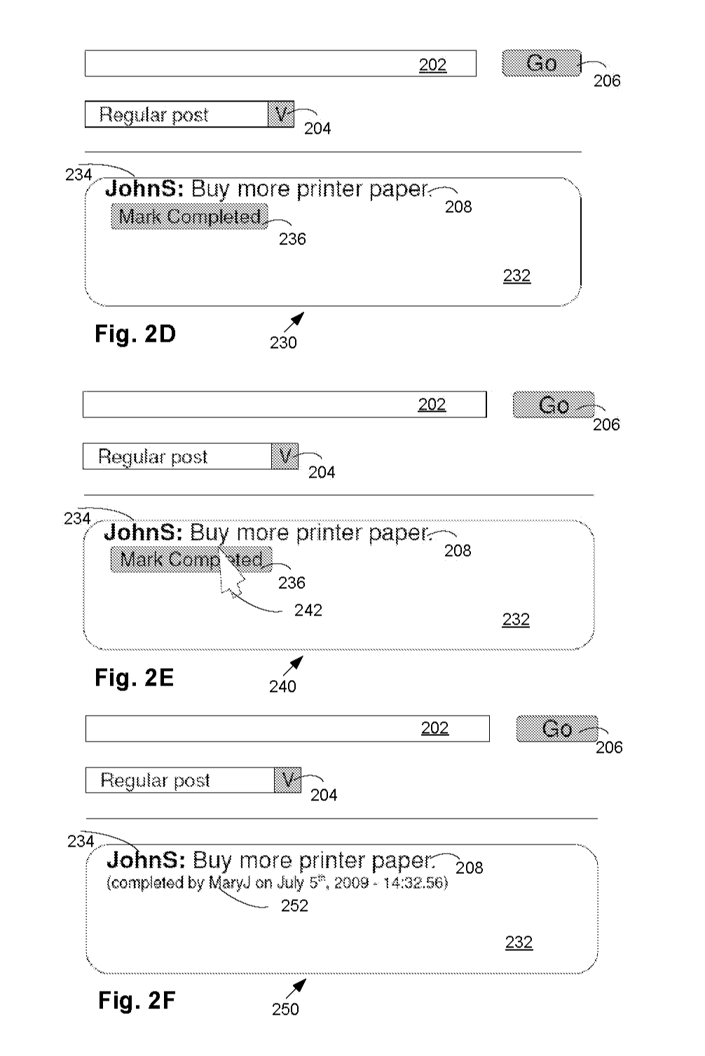

FIGS. 2A to 2F are representative screenshots 200, 210, 220, 230, 240 and 250, in accordance with one embodiment, of a user interface for posting an electronic communication with interactive content (for example by a first user using a first communication device) and for interacting with such communication and interactive content (for example by a second user using a second communication device). The screenshots may represent a portion of a web-page user interface.

FIG. 2A shows a screenshot 200 of an interface for composing and sending a new message (micro-blog post). The interface comprises a form portion 202 for receiving text (e.g. 208) and a control 206 for invoking a post action to communicate the message to a server. The interface further comprises a further control 204 that provides a selectable option for including interactive content. In a default setting, in accordance with one embodiment, the control 204 indicates that a regular (non-interactive) post is to be composed and sent. FIG. 2B illustrates screenshot 210 in which the control 204 is selected via pointer 212 to present selectable options 214. The options include interactive content choices “Task”, “Confirm” and “Poll” as described further. FIG. 2C illustrates screenshot 220 in which the “Task” interactive content is selected and “Go” control 202 invoked by pointer 212 for sending the message (text 208 and interactive content 204). In addition, though not shown, the message may include user information for identifying the posting user (e.g. by user name (e.g. “JohnS”), code or otherwise) and other information as may be applicable for storing and/or communicating the message via the micro-blog service.

FIG. 2D shows a screenshot 240 providing an interface for comprising a micro-blog message and for viewing a posted micro-blog message. Message viewing portion 232 displays the message composed and sent as illustrated with reference to FIGS. 2A to 2C. In the present embodiment, all users with access to the micro-blog may view the message. The message viewing portion of the interface comprises a text portion for showing the message text 208 as well as user identification 234 for the posting user. Other information (e.g. time of posting), source, etc. may be shown. Further included is an interactive control 236 (e.g. a button) which any of the users may invoke, for example to send a reply posting defining an interaction with the micro-blog posting being viewed. The interactive content of the present example message represents a “Task” which requires a completion by at least one of the users. The control represents a manner of marking the task completed. A user (e.g. MaryJ) may complete the task and invoke control 236 as illustrated in screenshots 240 and 250 of FIGS. 2E and 2F.

In screenshot 240, pointer 242 of MaryJ's computer is invoked to select the control 236. The invocation of the control 236 may occasion a message to the micro-blogging server indicating completion at a time and date of the specific task (that is the completion message may be linked or otherwise associated with the original Task message of JohnS). FIG. 2F illustrates an updated message viewing interface 232 in which the control is replaced by a message 252 indicating the task completion for all users to see. Optionally, though not shown, the server may also send a communication (such as an electronic message) to the original posting user (e.g. via e-mail or other direct message technique that may be configured within the micro-blogging service). A counter of outstanding tasks posted by a specific user may be maintained and updated. The user may be provided with a profile page or tab etc. to present such information.

The interfaces thus described may be configured via software, using known technologies such as the AJAX framework for implementing asynchronous communications and presentation: HTML or XHTML and Cascading Style Sheets (CSS) may be used to define the presentation aspects; Extended Mark-up Language (XML) and Extensible Stylesheet Language Transformations (XSLT) may be used to define the data/messages and transform same; XMLHttpRequest object may be used for asynchronous communication; and JavaScript® may be used for interactivity and to tie the operations together. Complimentary technologies may be used on the server side. In addition, the server may use various database technologies to group users, store messages, determine which messages are viewable by which users or groups and to associate subsequent messages (e.g. a reply defining an interaction) with previous messages for implementing the interactive and collaborative features described herein.

For example, with reference to the sequence of FIGS. 2A to 2F, a server may associate the posted message of JohnS to a specific group of users (or the group to the postings of JohnS) When viewing JohnS's posting, these users are also presented, at least initially, with the control 236. A response (invocation of control 236) received from any of these users (including JohnS) is associated with the original posting and in accordance with the type of interactive posting, the original posting may be re-rendered so that the original control 236 is replaced by the completion message. For example, an update may be received via the AJAX framework by any of the users' respective computers presenting a particular web-page comprising the micro-blog post. Optionally JohnS may receive other direct message or information following a completion. JohnS may provide an email address in his profile provided by the micro-blogging service (i.e. server) and enable receipt of direct messages via email.

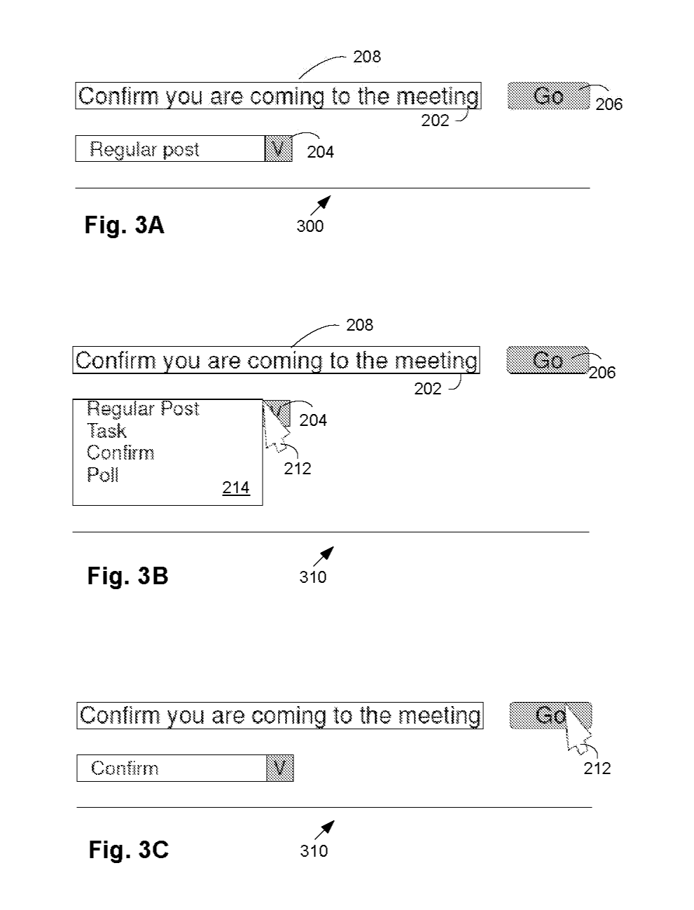

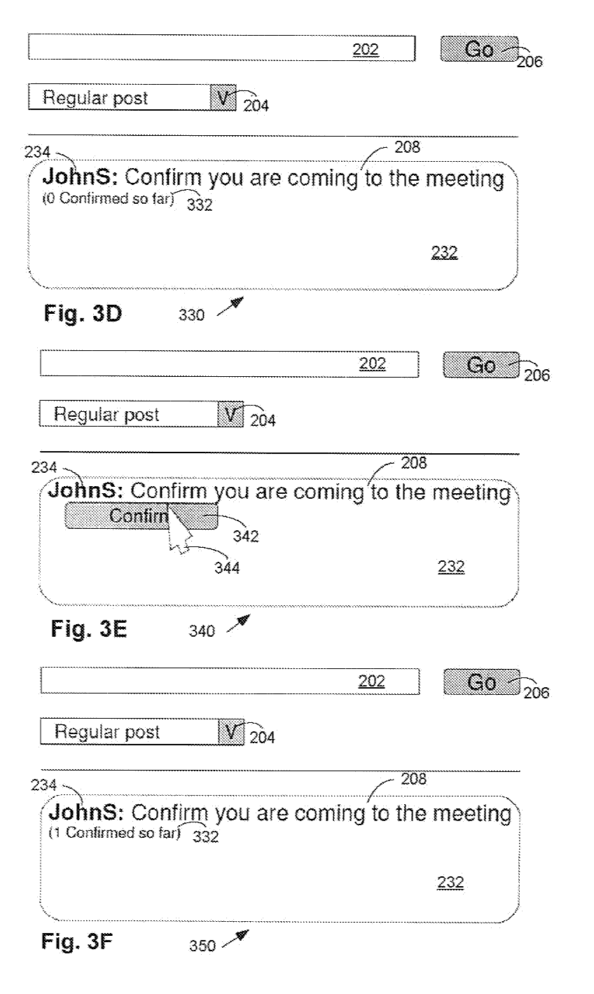

FIGS. 3A to 3F are representative screenshots 300, 310, 320, 330, 340 and 350 of a user interface for posting an electronic communication with interactive content and for interacting with such interactive content by one or more users, in accordance with another embodiment. FIGS. 3A to 3C are similar to FIGS. 2A to 2C and represent a user interface for composing and sending a message with interactive content. In the present embodiment, the interactive content comprises a “Confirm” type interactive message. Other users in the group are asked to confirm a particular thing such as a fact, choice, action, etc. which may be set forth in the text 208. FIGS. 3D to 3E illustrate the presentation of the interactive message posting, interaction with it and rendering of such results.

FIG. 3D illustrates a screenshot 330 showing an interface for composing a new message and for viewing a posted message similar to FIG. 2D. FIG. 3D represents a screenshot as presented to user JohnS, the originator of the posting. In contrast to the scenario of FIGS. 2D-2F, in the present example, the viewing of a posted message may differ for different users. JohnS is presented with a count of confirmations received. With reference to FIG. 3E, other users in the group are presented with a control 342 requesting confirmation. Invocation of this control 342 (e.g. using pointer 344) invokes a message to the server comprising a confirmation for a specific user (e.g. MaryD) to the specific confirm posting. Following the invocation, JohnS and MaryD respectively are presented with the interface depicted in screenshot 350 of FIG. 3F. Other users are presented with the interface of FIG. 3E until the control 343 is invoked by the respective user. In response to the invocation of the confirm control, the count is increased and the confirm message 332 is updated. Other alternatives may be envisioned whereby the confirm count is presented and updated to all users regardless of whether a particular user has invoked the confirm control. Upon invocation by a particular user, that control is no longer operational/rendered for that user.

Similar to the operation of the scenario in FIGS. 2A to 2D, posting the new confirm message sends data to the server where it is stored and a number of confirmations are set to 0. A list is maintained of the confirmed users (JohnS may be automatically added). The presentation side of the server (i.e. that configuration which presents postings for users through a web-interface, for example), receives the data and formats it according to posts state (responsive to the confirmed user list and the user requesting the presentation of the post). Since JohnS is in the confirmed list, JohnS is given data to present the confirm count but not the confirm control. Others (e.g. MaryJ) not in the list are given data to do the opposite. When MaryJ “clicks” the control, JavaScript and the AJAX framework can communicate (e.g. XMLHttpRequest) to the server. The number of confirmations is increased in response. MaryJ is added to the list in response. When MaryJ or another user in the group and in the confirm list views the posting, the confirm count is presented. Other users will see the confirm control.

Though described with reference to a web-based interface, for example, for execution within a browser using web pages and related technologies, it will be apparent that other implementations may be contemplated, such as native applications for desktops, laptops and smaller mobile devices (PDAs, Smartphones, etc.).

In an embodiment, the service (server) may be configured to receive new posts via other communication protocols and/or standards such as email or SMS. To signal an interactive micro-blog post, the post may include a keyword or code for interpretation by the service to distinguish the post from a non-interactive post and other interactive content. The keyword/code may be a prefix to the posting, appearing at the beginning of the post. A micro-blog post comprising “task call client @username” may establish a “TASK” type interactive post for user=“username” to “call client”. The interactive posting may be presented (e.g. via web page or native application) to user=“username” with a control which when invoked indicates that the task is completed. When presented to others, such presentation may not show the posting (treating it as private between originator and “username” or may not show the completion control. A posting by user=“username” comprising “done call” or similar may be used to confirm the completion of the TASK. To properly associate a completion posting with a corresponding task, additional information may be necessary (e.g. the completion posting may include data comprising: originator username, a message number of the originating message, a task code or count assigned to the task, etc.)

In another example, a posting of “conf Meeting is one hour earlier today” may create an interactive posting of type “CONFIRM”, requesting receiving users to confirm the new information.

The service may be configured to communicate interactive postings, particularly TASK or CONFIRM or similar postings to users via email. In some embodiments, users may enable this option selectively (i.e. configure their respective profiles). A reply to a TASK type posting received by email with a “done” reply (e.g. in the message body or re: line) may complete the assigned task, using email data (time etc.) to complete any required information to be associated with the interactive posting.

In an alternative embodiment, the posting user (or some or all users in the group) may see who from the group has confirmed a posting. This may be presented along with or in lieu of the confirm count.

In addition to “Task” and “Confirm” types, a “Poll” type interactive feature may be provided whereby users may select a poll option. The composition interface may permit the specification of two or more poll choices (Step 112 of FIG. 1). Presenting the post may show the choice options for invocation by a member of the group or the public. A count of each choice received by the server may be maintained. The server may keep track of users who have submitted a response to the poll. The current count may be displayed after responding for example or the count may only be presented to the poll originator, for example.

A “Budget/Cost” interactive type illustrates how multiple micro blog posts could collaborate. A user could post a “Budget” post and give it a value (e.g. $4000). There can then be subsequent “Cost” posts of different values (e.g. “New Ram chips: $400). The posts will subtract the difference to maintain the running total left in the “Budget” (e.g. $900), and send an alert or notification if the costs have gone over budget or are close to doing so.

A “List Build” interactive type enables a user to define and add to a list (such as whom to invite or what to pack for a camping trip). Other users can add to the list found within the single post.

A “Question & Answer” interactive type enables a user with a question to post it in the text of a post and mark it as a question. When presented, the post appears with the text and a form (empty text box) to receive a reply “answer” via a control button where other users can input and submit their answers.

A “Multiple Choice” interactive type allows a user to post a question with multiple choice answers. The question will appear as the post's text and the different answers will appear as radio buttons or check boxes with a submit button. Other users can try to answer the question and be told if they are wrong.

An “Academic Grade Tracking” interactive type enables a user can post a course code, mark, and weight and the posts will maintain the over all grade. Other (simple) mathematical formula may be defined by originating posters (e.g. tip calculator).

The interactive or collaborative content of a micro-blog post does not have to be constructed and supported by the micro-blog service itself wholly or specifically. Infrastructure can be added for the post to support interactive/collaborative media from third party sources. This makes the micro-blog even more versatile as outside users can then design their own interactive/collaborative functions and use it through the micro-blog. For example, the service may look to a third party service for rules to process interactive posts.

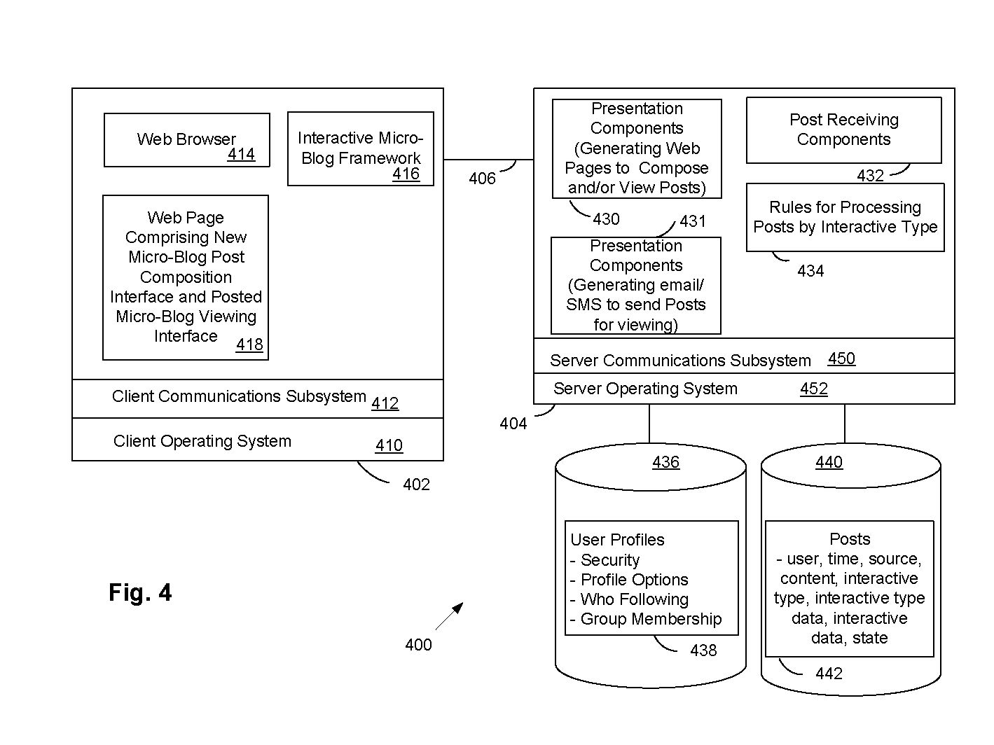

FIG. 4 is a block diagram showing an example and simplified communication network 400 wherein a computer 402 is coupled via a public, wide area network 406 to a web server 404 providing a web site-based micro-blogging service in accordance with an embodiment of the invention.

Computer 402 may comprise a personal computer, workstation, laptop, PDA, Smartphone or other device capable of communication with a web server. Details of such a computer are not shown. Typically such a computer comprises a programmable CPU (e.g. a microprocessor); memory or other storage devices (e.g. RAM, ROM, flash, optical or other disk storage, etc.) for storing instructions and data for configuring and operating the computer; and one or more input and/or output devices (e.g. keyboard, keys, buttons display screen (possibly a touch sensitive display screen providing I/O features), lights, speaker, microphone, pointing device, trackball, track wheel, track pad. Such devices also comprise one or more wired and/or wireless communication interfaces (e.g. USB, cellular, Bluetooth™, WiFi, WiMAX, etc.). Computer 402 in FIG. 4 represents a typical user or client computer configured in accordance with an embodiment of the present teachings and is schematically represented for simplicity showing computer program instructions and data defining one or more software components. Persons of skill in the art will appreciate that other representations and varied software components may be illustrated. It is also appreciated that more than one computer 402 may be coupled for communication with server 404.

Server 404 is similarly a simplified illustration of a web server environment. Not shown are various network components such as load balancing components, firewalls, routers, etc. Server 404 may comprise one or more computers. Server 404 in FIG. 4 is schematically represented for simplicity showing computer program instructions and data defining one or more software components in accordance with an embodiment of the present teachings. Persons of skill in the art will appreciate that other representations and varied software components may be illustrated.

Computer 402 is showing comprising an operating system 410 (e.g. Microsoft Windows™, Apple OS™, Linux™, etc.) a client communications subsystem 412 (e.g. for communicating via network 406 in a wired and/or wireless mode), various client applications (not shown) for example to view and/or edit applicable data files, a web browser 414 and an interactive micro-blog framework 416 for interacting with web pages, the browser 414 and other features of web server 104. The framework 416 may comprise an AJAX framework as previously described. The framework is depicted as separate from the browser 414, web page 418 and OS 440 for convenience only but one or more components thereof may overlap with other components. A representative web page 418 is shown, received from server 404, comprising an interface for composing a new micro-blog post and an interface for viewing micro-blog posts from server 404. It is also understood that portions of the web page may comprise script, HTML, XML, XSLT, and/or CSS coding as may be applicable.

Server 404 comprises a server operating system 450, communication subsystem 452, and components (generally software) of a server side micro-blogging service such as presentation components 430 for defining web pages and/or 431 for defining electronic message notification (e.g. email or SMS), post (message) receiving components 432 (whether for web-based posts, email or SMS, etc.) and rules for processing the posts 434 generally by interactive type of the post. Server 404 may be coupled to one or more stores (e.g. databases) 436 and 440 for storing user profile data 438 and posts 442. Though shown as two separate stores, one or more than two such stores may be used. Additional server and network technologies for providing a scalable, robust web service are well known but are not shown.

User profile data 438 may comprise security information (e.g. login information, file access or other permissions) profile options (such as whether to provide SMS or email notification or other direct messages, favourites, etc.) as well as data identifying how to communicate micro-blog posts among the users, for example, indicating which users a particular user is following or groups to which the user belongs for posting/receiving posts for a group.

Post data 442 may comprise interactive posts and non-interactive posts. As described previously, interfaces within pages 418 may be configured to enable a user to post a micro-blog message with interactive content in accordance with one or more types. A stored post may comprise data to identify the posting user, the time of the post and the source of the post (where source may indicate various communication technologies (web, SMS, email) or applications (e.g. for a mobile device) from or through which a post is originated). Further data may include the content, interactive type (e.g. “TASK”, “CONFIRM”, “POLL”, etc. and interactive type data (e.g. such data to define the choice). As well, an interactive post may include (or be associated/linked to) interactive data related to the interactive type of the post. Such data may include a confirm count, poll results, a list of users who have confirmed a post of interactive type “CONFIRM”, links to messages (posts) received in response to the interactive post, etc.

Server 404 may be configured to maintain a state of respective interactive micro-blog posts. Applicable states of such posts may vary with the interactive type of such posts. For example, a new “Task” type post may establish an entry in database 440 for the post with a state indicating “requiring completion”. Communicating this posting by presenting in a web page may define a completion control (button) in accordance with the state. Communicating this posting by sending an email message may define a message re: line or message body to indicate completion is required in accordance with the state. A response to the interactive post (e.g. invoked from the control or by email, etc) may be received and processed to change the state to indicate that the task is completed. Completion data may be received and stored to identify the completing user and/or completion time. Subsequent presentation may reflect this change in state (e.g. so that the control is not shown). Communicating Rules 434 may process an incoming electronic communication (whether such includes data defining a new micro-blog post and associated type or data representing an interaction with a particular interactive micro-blog post) to assist with storing of post data to database 440 received via post receiving components 430 and/or to update a viewing interface of the particular micro-blog post. The rules may process data from stored posts, for example, on behalf of or for presentation components 430, 431 to assist with how interactive posts are presented to specific users. For example, when specific users request a page 418, components 430 may reference data 438 to identify posts within data 442. Rules 434 may process the identified posts so that the interactive features are presented appropriately or updated appropriately in response to interactions.

In another embodiment (not shown), rules or functionality thereof may be provided by a separate service (e.g. hosted and/or operated on a same or a remotely coupled server) such as a third party service.

Although specific embodiments of the invention have been described herein, it will be understood by those skilled in the art that variations may be made thereto without departing from the spirit of the invention or the scope of the appended claims.

1. A method of facilitating collaborative communication comprising:
receiving a micro-blog post comprising an interactive type for facilitating interaction with the micro-blog post;
storing the micro-blog post and maintaining a state, in accordance with the interactive type;
communicating the micro-blog post in accordance with the respective interactive type and state to facilitate interacting with the micro-blog post; and
updating the state in response to a reply communication representing an interaction with the micro-blog post.

2. The method of claim 1 wherein the step of communicating comprises providing a viewing interface for viewing the micro-blog post in a web browser, said viewing interface comprising a control defined in response to the interactive type and state for interacting with the micro-blog post.

3. The method of claim 1 further comprising defining and storing user profiles comprising data identifying respective users and specifying how to communicate micro-blog posts among the respective users and wherein the step of communicating is responsive to the user profiles thereby to selectively present the micro-blog post for collaborative interaction.

4. The method of claim 1 further comprising updating the communicating of the micro-blog post in response to the updating of the state.

5. A method of facilitating collaborative communication comprising:
providing a web-based communication interface for receiving respective electronic communications, each electronic communication comprising data defining a particular micro-blog post and an interactive type associated to the particular micro-blog post;
providing a web-based viewing interface for presenting respective micro-blog posts, the viewing interface configured to present a particular micro-blog post in accordance with rules responsive to the associated interactive type to facilitate interacting with the particular micro-blog post and further configure to define and send an electronic communication representing the interaction; and
providing a web-based communication interface for receiving the electronic communication representing an interaction with a particular micro-blog post.

6. The method of claim 5 wherein the viewing interface comprises at least one control for interacting with a particular micro-blog post, the control defined in response to the associated interactive type.

7. The method of claim 5 comprising processing the electronic communication representing the interaction and updating the viewing interface presenting the particular micro-blog in response.

8. The method of claim 5 comprising processing and storing the electronic communication in accordance with the interactive type.

9. The method of claim 5 comprising providing a web-based interface for composing a particular micro-blog post and associated interactive type.

10. The method of claim 5 further comprising defining and storing user profiles comprising data identifying respective users and specifying how to communicate micro-blog posts among the respective users and wherein the step of providing a web-based viewing interface is responsive to the user profiles thereby to selectively present the particular micro-blog posts for collaborative interaction.

11. The method of claim 5 wherein the interactive type indicates one of a “CONFIRM”, POLL”, “TASK”, “BUDGET/COST”, “LIST BUILD”, “QUESTION & ANSWER” “MULTIPLE CHOICE” type of interactive micro-blog post.

12. The method of claim 5 wherein the viewing interface comprises a web-page for use by a web browser of a client computer system.

13. The method of claim 12 wherein the client computer system, web browser and/or web-page are configured to provide an AJAX-based framework for communicating the electronic communications.

14. A method of interactive and collaborative communication comprising:
receiving a micro-blog post from a micro-blogging service, said micro-blog post comprising an interactive type, said service maintaining a state of said micro-blog post for facilitating interaction; and
communicating a reply to the micro-blogging service in accordance with the interactive type, the reply representing an interaction with the micro-blog post to invoke an updating of the state.

15. The method of claim 14 further comprising, receiving an update to the micro-blog post from the micro-blogging service in response to the updating of the state.

16. The method of claim 14 comprising presenting the micro-blog post in accordance with the interactive type to facilitate an interaction.

17. The method of claim 16 wherein the micro-blog post is presented in a viewing interface in accordance with the interactive type and state of the micro-post.

18. The method of claim 14 further comprising composing and sending to the micro-blogging service for further communication for collaboration a micro-blog post comprising an interactive type.

19. A method interactive and collaborative communication comprising:
composing and sending to a micro-blogging service a micro-blog post comprising an interactive type;
wherein said micro-blogging service is configured to maintain a state of said micro-blog post, communicate the micro-blog post for interaction in accordance with the interactive type and state, and receive at least one reply defining said interaction to update the state.

20. The method of claim 19 comprising receiving and presenting the micro-blog post in a viewing interface in accordance with the interactive type and state.
